(19) United States
(12) Patent Application Publication
(10) Pub. No.: US 2023/0082572 A1
(43) Pub. Date: Mar. 16, 2023

(54) USE OF NATIVE AND PURIFIED PEA STARCH FOR THE PREPARATION OF WET PET FOOD

(71) Applicant: ROQUETTE FRERES, Lestrem (FR)

(72) Inventors: Alice RIME, VERLINGHEM (FR); Florian SARRAZIN, FOUQUEREUIL (FR)

(21) Appl. No.: 17/759,804

(22) PCT Filed: Jan. 25, 2021
(86) PCT No.: PCT/FR2021/050125

§ 371 Date: Jul. 29, 2022

(30) Foreign Application Priority Data
Jan. 30, 2020 (FR) FR2000931

(51) Int. Cl. A23K 20/163; A23K 10/20; A23K 50/48

(52) U.S. Cl. CPC A23K 20/163; A23K 10/20; A23K 50/48

(57) ABSTRACT

The invention relates to a meat-based wet food composition for pets, characterized in that it contains native and purified pea starch as a texturing agent.

The present invention relates to a novel meat-based wet food composition for pets, characterized in that it contains native and purified pea starch as a substitute for the texturizers conventionally used (wheat or legume flours, hydrocolloid mixtures, plasma, etc.).

More particularly, the present invention recommends preferably using a particular content of native and purified pea starch in said food compositions, to ensure the required qualities of firmness and stability.

### FIELD OF THE INVENTION

The preparation of animal feed, especially pet food, involves different types of raw materials and ingredients.

These are mostly raw materials of plant or animal origin.

The ingredients can be texture agents, vitamins and/or mineral supplements.

The raw materials of animal origin are provided either fresh, chilled or frozen. They are first ground up.

They are then sent to a blender where the other components of the formula are added.

Most of the time, these are products extracted from cereals, vitamins, mineral supplements and texturing agents.

The resulting mixture is ready for the subsequent steps of the method.

Within the category of food used for pets, there are three basic subdivisions: dry food, semi-moist food and wet food.

The technical field to which the present invention relates is that of wet foods.

Feed supplements and animal specialties are a fast growing sector in the animal feed industry.

The following are thus proposed:
Gelling agents, essential for the manufacture of regular meat-based products, pâtés and gelled products. Gelling agents form a gel during sterilization and play a decisive role in the appearance and texture of the food.
Thickeners, essential for the manufacture of pieces in sauce. They ensure the homogeneity of the components in the products in sauce as well as the appearance and texture of the sauces. They also promote the homogeneity and texture of the food.
Filling tools, which are used to control viscosity and rheology during the manufacturing process and optimize the execution of the process.
Taste-enhancing products that have the effect of forming aromas under sterilization conditions (Maillard reaction) and increase the taste quality of the food for the pet.

As far as texturing or stabilizing agents are concerned, it is commonly accepted in the state of the art that more than 80% of all culinary products are based on wheat flour.

However, alternatives, especially non-allergenic ones, are increasingly requested by consumers, not only for their own food needs, but also for their pets, based on the aphorism that “if it's good enough for me, then it's good enough for my pet”.

However, wheat flour substitutes in gluten-free products (gluten being a “natural” binding agent) often have the disadvantage of making the processing procedure more delicate and requiring special manufacturing processes in order to meet the expected quality.

To meet the demands of consumers, pet food formulators are increasingly developing new “grain-free” texturizers.

Three families of texturizers are usually proposed in a grain-free context:
1) Plasma (for its richness in proteins and its effect on firmness).
2) Hydrocolloid mixtures,
3) Legume flours, or even native starches partially extracted from peas.

A first proposed family is that of plasma and dehydrated blood, which are allowed in conventional methods for producing pet food.

In the state of the art, plasma is recommended to improve the juiciness of food pieces (for example meat-based), and as a binding agent in a wet medium.

The plasma is generally added in dried form by atomization.

This additive is especially recommended for improving the hardness of the pieces, compared to formulas wherein the binder conventionally used is wheat gluten.

However, the impact of this type of additive on the palatability of the food produced must be managed.

A second recommended family is that of the hydrocolloids. It is part of the daily life of consumers, and brings added value to many products, thanks to its many technical properties, such as:
Texturing,
Thickening,
Water retention,
Emulsifying,
Stabilizing,
Foaming,
Film-forming,
Gelling,
Binding,
Adherence.

In addition to gelatin, which is one of the most widely used hydrocolloids in the world, other hydrocolloids include: agar, alginates, gum arabic, carrageenan, cassia, cellulosics (CMC, MCC, MC/HPMC), gellan gum, guar, konjac, locust bean gum (LBG), pectin, starch, tara gum, and xanthan.

Carrageenan, for example, is a polysaccharide (galactan) extracted from red algae used as a thickening and stabilizing agent in the food industry. Its code is E407 in the classification of food additives for human food.

Carrageenans make it possible to form gels at high temperatures (up to 60° C.) and are therefore of interest compared to traditional animal gelatins.

However, scientists have been led to ask serious questions about the toxicity of this additive in food (cf. https://en.wikipedia.org/wiki/Carrageenan).

The third family of texturizers concerns formulas intended for animals that are prepared from leguminous plants, such as peas, chickpeas or lentils.

Tests have indeed shown that working with pea flour makes it possible to replace wheat flour in pasta, cookies, bread, cakes and many other culinary applications.

The promotion of these pea flours is done by highlighting their technological properties (binding and texturing abilities, capacity to increase water binding, etc.) but also their nutritional properties (high protein content, balanced amino acid profile, etc.).

In this complex matrix of ingredients (carbohydrates, proteins, fibers, etc.), it is known that pea protein, pea starch and pea fiber all have proven functionality in dry and wet pet foods and treats.

These benefits have proven useful in many marketed pet products, especially in the so-called “natural” market segments.

For example, it is known that the starch fraction of pea flour can provide nutritional benefits, especially through its low glycemic index, its absence of allergens, etc.

Pea starch is a very effective binder and has a neutral impact on the quality of formulated foods, and even a positive impact on food color. This function is also used for pet food.

Due to its viscosity, gel-forming ability and texturing properties, pea starch is an ingredient of choice.

However, it appears in the state of the art that pea starch is never provided in its purified form in these food compositions but in a non-purified form (protein content between 10 and 15%), or even in the form of flour.

There is still an unmet need to propose an alternative food texturizer to the solutions already proposed to replace wheat flour in wet food compositions for pets.

### OBJECT OF THE INVENTION

The present invention relates to a meat-based wet food composition for pets, characterized in that it contains native and purified pea starch as a texturizer.

In some embodiments, the native and purified pea starch is the sole texturing agent present in the food composition.

In one embodiment of the invention, the food composition does not contain wheat flour. In one embodiment, the food composition does not contain legume flour. In one embodiment, the food composition does not contain hydrocolloids. In one embodiment, the food composition does not contain plasma. In one embodiment the food composition does not contain egg. In one embodiment, the food composition does not contain dietary fiber.

In some embodiments, the food composition does not contain any of the texturing agents mentioned hereinbefore, so that the native and purified pea starch is introduced as the sole texturing agent of the wet food composition.

In some embodiments, the food composition is characterized in that the native and purified pea starch is introduced at a content of between 4.5% and 10% by weight of the total food composition, preferably a content of between 5% and 8% by weight of the total food composition, more preferably a content of about 7% by weight of the total food composition.

The invention also relates to the use of native and purified pea starch as a food additive, in particular as a texturing agent, in a meat-based wet food composition for pets.

In some embodiments, the native and purified pea starch is used as the sole texturing agent in the food composition.

In one embodiment of the invention, the food composition does not contain wheat flour. In one embodiment, the food composition does not contain legume flour. In one embodiment, the food composition does not contain hydrocolloids. In one embodiment, the food composition does not contain plasma. In one embodiment the food composition does not contain egg. In one embodiment, the food composition does not contain dietary fiber.

In some embodiments, the food composition does not contain any of the texturing agents mentioned hereinbefore, so that the native and purified pea starch is introduced as the sole texturing agent of the wet food composition.

In some embodiments, the use is characterized in that the native and purified pea starch is introduced at a content of between 4.5% and 10% by weight of the total food composition, preferably a content of between 5% and 8% by weight of the total food composition, more preferably a content of about 7% by weight of the total food composition.

The invention also relates to the method for manufacturing a meat-based wet food composition for pets, characterized in that after grinding the meat, native and purified pea starch is introduced to the mixture.

In some embodiments, the method is characterized in that the native and purified pea starch is introduced as the sole texturing agent in the wet food composition.

In one embodiment of the invention, the method does not comprise the use of wheat flour. In one embodiment, the method does not comprise the use does not contain legume flour. In one embodiment, the method does not comprise the use of hydrocolloids. In one embodiment, the method does not comprise the use does not contain plasma. In one embodiment the method does not comprise the use of egg. In one embodiment, the method does not comprise the use of dietary fiber.

In some embodiments, the food composition does not comprise the use of any of the above-mentioned texturing agents, so that the native and purified pea starch is introduced as the sole texturing agent of the wet food composition.

In some embodiments, the method is characterized in that the native and purified pea starch is introduced at a content of between 4.5% and 10% by weight of the total food composition, preferably a content of between 5% and 8% by weight of the total food composition, more preferably a content of about 7% by weight of the total food composition.

In some embodiments, a food composition, use and method disclosed herein are characterized in that the native and purified pea starch contains a protein content of not more than 1.5% by dry weight with respect to the dry weight of the pea starch, preferably a protein content between 0.35% and 1.2% by dry weight with respect to the dry weight of the pea starch.

### DETAILED DESCRIPTION

Thus, the invention relates to a novel meat-based wet food composition for pets, characterized in that it contains native and purified pea starch as a substitute for the texturizers conventionally used (wheat or legume flours, hydrocolloid mixtures, plasma, etc.).

More particularly, the native and purified pea starch content is adjusted so as to give the food produced the required firmness and stability.

According to the present invention, a pet food composition is considered to be “wet” when it contains at least 25%, preferably at least 30%, at least 35%, at least 40%, at least 45%, at least 50%, at least 55%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, even more preferably at least 75% by weight of water with respect to the total weight of said food composition.

Advantageously, the term “pea” is considered herein in its broadest sense, including in particular:
all the wild-type varieties of “smooth pea”, and
all the mutant varieties of “smooth pea” and of “wrinkled pea”, regardless of the uses for which said varieties are usually intended (human food, animal feed and/or other uses).

Said mutant varieties are in particular those named “mutants r”, “mutants rb”, “mutants rug 3”, “mutants rug 4”, “mutants rug 5” and “mutants lam” as described in the article by C-L HEYDLEY et al. entitled “Developing novel pea starches”, Proceedings of the Symposium of the Industrial Biochemistry and Biotechnology Group of the Biochemical Society, 1996, pages 77-87.

“Pea starch” means any composition extracted, by any means, from peas, the starch content of which is greater than 40%, preferably greater than 50% and even more preferentially greater than 75%, these percentages being expressed as dry weight relative to the dry weight of said composition.

Advantageously, this starch content is greater than 90% (dry/dry). It may in particular be greater than 95%, including greater than 98%.

“Native” starch means a starch which has not undergone any chemical modification.

“Purified” pea starch means a pea starch extracted and isolated from pea flour by extraction processes developed in the pea starch sector, characterized in that its protein content does not exceed 1.5% by dry weight with respect to the dry weight of the pea starch, and is preferably between 0.35 and 1.2% by dry weight with respect to the dry weight of the pea starch.

In this case, the skilled person will easily find this quality of native and purified pea starch from the applicant company, under the trade name N735 pea starch.

The starch contents of native and purified pea starch are identical to those mentioned hereinbefore for “pea starch”.

The invention will be better understood on reading the example and the corresponding figures, example which is intended to be illustrative, only mentioning some embodiments and some advantageous properties according to the invention, and non-limiting.

### BRIEF DESCRIPTION OF THE FIGURES

FIG. 1 is a graph showing the firmness, after 0 freeze/thaw cycles, of a beef-based pâté prepared with different texturing agents.

FIG. 2 is a graph showing the firmness, after 3 freeze/thaw cycles, of a beef-based pâté prepared with different texturing agents.

FIG. 3 is a graph showing the variation in firmness, after 0 to 3 freeze/thaw cycles, of a beef-based pâté prepared with different texturing agents.

FIG. 4 is a graph showing the firmness, after 6 freeze/thaw cycles, of a beef-based pâté prepared with different texturing agents.

FIG. 5 is a graph showing the variation in firmness, after 0 to 6 freeze/thaw cycles, of a beef-based pâté prepared with different texturing agents.

### EXAMPLE

### Example—Implementation of a Native Pea Starch in a Beef-Based pâté

The analysis is carried out on the basis of the following recipe:

TABLE 1

| Recipe | 1 | 2 | 3 | 4 |
|---|---|---|---|---|
| Ingredients | Pea flour | Mixture of gelling | Native pea | Native pea |
| | 7% | hydrocolloids | starch 5% | starch 7% |
| | | E499/E407 | | |
| Water | 49 | 49 | 49 | 49 |
| Beef in pieces | 31 | 34.4 | 35 | 31 |
| Beef liver | 7 | 10.10 | 5 | 7 |
| NUTRALYS ® F85M | 6 | 6 | 6 | 6 |
| Native and purified | — | — | 5 | 7 |
| pea starch | | | | |
| N-735 | | | | |
| Mixture of gelling | — | 0.5 | — | — |
| hydrocolloids | | | | |
| E499/E407 | | | | |
| Pea flour | 7 | — | — | — |

The method for preparing the pâté is as follows:
1) Step of grinding and mixing in the Stephan
a) Grinding beef and beef liver in a Stephan grinder (Stephan Cutter, Stephan Machinery GmbH, Germany) at maximum speed (3000 rpm) for 2 minutes.
b) Adding the remaining ingredients and mixing at maximum speed (3000 rpm) for 2 minutes, under vacuum.
2) Packaging Filling glass bottles to 90% of their volume and crimping.
3) Sterilizing
Autoclave 121° C. during 1 h Equipment: Rotary bi-process STERIFLOW with a diameter of 900 mm-1 basket—Reference: NS 911 R MP FLW STEAM, year 2017, www.steriflow.com/en—Rotation: non (static)—heat treatment by sterilization with water cascade.

The recipes produced are assessed according to the following methods:
1) Texture analysis
The use of a TAXT2 texturometer makes it possible to assess the firmness of the pâté.
An analysis with a ball mobile makes it possible to mimic the pressure exerted by a spoon penetrating the pâté to remove it from its can.
Three repetitions were carried out.
An analysis with a “knife” mobile makes it possible to mimic the use of a knife to cut the pâté.
Two repetitions were carried out
2) Stability of the product after several freeze/thaw cycles:
a) Freeze/thaw protocol
The products are placed in the freezer for 1 hour to reach a temperature of −25° C., then stored in the freezer for 1 night at −15° C.
Thaw for 5 hours at room temperature.
These 3 steps are repeated in order to carry out as many freeze/thaw cycles as desired. From 0 to 6 cycles were carried out for this study.
b) Monitoring the variation in the texture
It is carried out according to the method disclosed hereunder with the texturometer, using the ball and knife mobile.

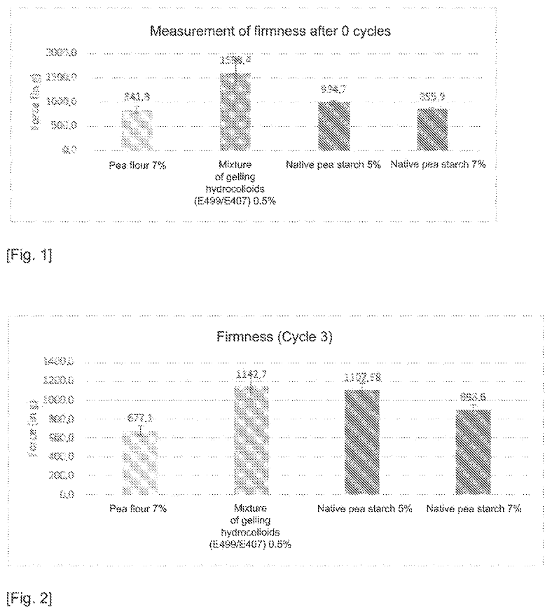

The results obtained are presented in FIG. 1.

It is noted that the formula with the mixture of gelling hydrocolloids E499/E407 makes it possible to obtain the product with the most firmness. The solution with 7% native and purified pea starch is the one closest to the tested solution with 7% pea flour.

1. Measurement of firmness after 3 cycles

The results obtained are presented in FIG. 2.

After 3 freeze/thaw cycles, 3 groups can be formed on the firmness criterion:
1. Recipe with 7% pea flour, appearing to be the least firm.
2. Recipe with 7% peas, intermediate.
3. Recipes with the mixture of gelling hydrocolloids E499/E407 and with 5% native pea starch, appearing to be the firmest.

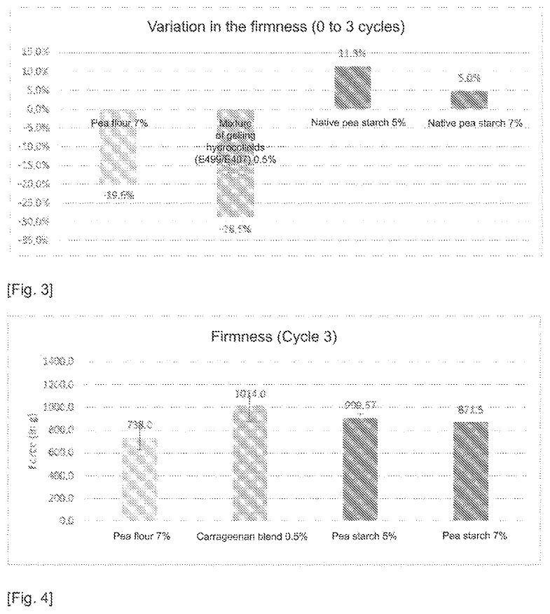

However, when considering the variation from 0 to 3 cycles, (FIG. 3) trends emerge. The recipes containing native and purified pea starch appear to be the most stable.

2. Measurement of firmness after 6 cycles

The results obtained are presented in FIG. 4.

After 6 cycles, it becomes complex to distinguish the 4 recipes with a texturometer. The recipe containing 7% pea flour is always the least firm of all.

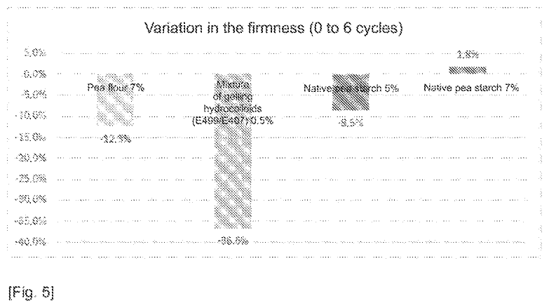

As for the variation in texture from 0 to 6 cycles (FIG. 5), it makes it possible to identify trends.

The recipe containing hydrocolloids (carrageenan blend) is the one with the least texture.

On the contrary, the recipes containing pea starch (5 and more particularly 7%) are the most stable.

The comparison of the formulas containing 7% native and purified pea starch with those containing 7% flour shows that:
In terms of firmness, the starch-based formulas are better,
In terms of stability, the starch-based formulas are also the best.

1. A meat-based wet food composition for pets, wherein it contains native and purified pea starch as a texturing agent.

2. The food composition according to claim 1, wherein native and purified pea starch is the sole texturing agent present in the composition.

3. The food composition according to claim 1, wherein the native and purified pea starch is introduced at a content of between 4.5% and 10% by weight of the total food composition, preferably a content of between 5% and 8% by weight of the total food composition, more preferably a content of about 7% by weight of the total food composition.

4. The food composition according to claim 1, wherein the native and purified pea starch contains a protein content of not more than 1.5% by dry weight with respect to the dry weight of the pea starch, preferably a protein content of between 0.35% and 1.2% by dry weight with respect to the dry weight of the pea starch.

5. A use of the native and purified pea starch as a texturing agent in a meat-based wet food composition for pets.

6. The use according to claim 5, wherein the native and purified weight starch is used instead of any other texturing agent.

7. The use according to claim 5, wherein the native and purified pea starch is introduced at a content of between 4.5% and 10% by weight of the total food composition, preferably a content of between 5% and 8% by weight of the total food composition, more preferably a content of about 7% by weight of the total food composition.

8. The use according to claim 5, wherein the native and purified pea starch contains a protein content of not more than 1.5% by dry weight with respect to the dry weight of the pea starch, preferably a protein content of between 0.35% and 1.2% by dry weight with respect to the dry weight of the pea starch.

9. A method for manufacturing a meat-based wet food composition for pets, wherein after grinding the meat, native and purified pea starch is introduced to the mixture.

10. The method according to claim 9, wherein the native and purified pea starch is introduced at a content of between 4.5% and 10% by weight of the total food composition, preferably a content of between 5% and 8% by weight of the total food composition, more preferably a content of about 7% by weight of the total food composition.

11. The method according to claim 9, wherein the native and purified pea starch contains a protein content of not more than 1.5% by dry weight with respect to the dry weight of the pea starch, preferably a protein content of between 0.35% and 1.2% by dry weight with respect to the dry weight of the pea starch.
